(19) United States
(12) Patent Application Publication
(10) Pub. No.: US 2004/0099289 A1
(43) Pub. Date: May 27, 2004

(54) Method for rinsing cleaned objects

(75) Inventors: Hidehiko Kawaguchi, Tokyo (JP); Yuji Shimizu, Tokyo (JP); Shingo Hosohata, Tokyo (JP); Koichi Tamoto, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignees: Kaijo Corporation, Tokyo (JP); NEC Electronics Corporation, Kanagawa (JP)

(21) Appl. No.: 10/645,773

(22) Filed: Aug. 21, 2003

Related U.S. Application Data
(63) Continuation of application No. 09/531,716, filed on Mar. 21, 2000, now abandoned.

(30) Foreign Application Priority Data
Mar. 25, 1999 (JP) 11-82504

(51) Int. Cl. B08B 3/00; B08B 7/04

(52) U.S. Cl. 134/27; 134/28; 134/29; 134/34; 134/2; 134/3

(57) ABSTRACT

A method is disclosed for rinsing a cleaned object whereby cleaning chemical liquid adhered to the object is substantially removed therefrom while substantially reducing the amount of pure water used for rinsing. The object with cleaning chemical liquid adhered thereto is immersed in a rinse bath filled with pure water, so that the cleaning chemical liquid may be rinsed off therefrom while pure water is continuously fed to the rinse bath. A neutralizing chemical liquid of alkalinity or acidity opposite that of the cleaning chemical liquid is added to the pure water in the rinse bath by feeding the neutralizing chemical liquid using a feed pump and a pump controller. Thus, the cleaning chemical liquid is neutralized by the neutralizing chemical liquid, to thereby be converted into a salt readily soluble in pure water, which salt is then discharged together with the pure water by overflowing the rinse bath.

### CROSS-REFERENCE TO RELATED APPLICATIONS

The present application is a continuation of U.S. application Ser. No. 09/531,716, filed on Mar. 21, 2000, the disclosure of which is incorporated by reference herein.

### BACKGROUND OF THE INVENTION

This invention relates to a method for rinsing a cleaned object, and more particularly to a method for rinsing a cleaned object such as a cleaned semiconductor wafer, a cleaned glass element for an LCD or the like which has been cleaned with a cleaning chemical liquid.

Cleaning of an object using a cleaning chemical liquid which have been conventionally practiced will be described with reference to FIG. 4.

An object W such as a semiconductor wafer, a glass element for an LCD or the like which is to be cleaned with a cleaning chemical liquid is immersed in a cleaning chemical liquid bath 12 filled therein with the cleaning chemical liquid 11 while the cleaning chemical liquid 11 is permitted to overflow the chemical liquid bath 12. The cleaning chemical liquid 11 overflowing the cleaning chemical liquid bath 12 is collected in a cleaning chemical liquid recovery tank 13 and then circulatedly fed through a circulation filter 15 toward the cleaning chemical liquid bath 12 by means of a circulation pump 14. Then, the cleaning chemical liquid 11 is injected through injection pipes 16 into the cleaning chemical liquid bath 12 toward the object W, so that liquid chemicals adhered to a surface of the object W in a previous chemical treatment may be removed by the cleaning chemical liquid 11. Then, the thus cleaned object W is transferred to a rinse bath 22 filled therein with pure water 21 for rinsing, to thereby be immersed in the pure water 21. The rinse bath 22 is continuously fed with pure water through a pure water feed passage 29. The pure water for rinsing is emitted toward the cleaned object W by means of emission pipes 23, resulting in the cleaning chemical liquid adhered to the cleaned object W being removed therefrom. Pure water after rinse which overflows the rinse bath 22 is recovered in a pure water recovery tank 24 and then discharged outwardly from the tank 24.

A variety of chemical liquids have been conventionally used as the cleaning chemical liquid 11 described above. For example, the chemical liquids include acidic cleaning chemical liquids such as a sulfuric acid-hydrogen peroxide mixture (SPM), a hydrochloric acid-hydrogen peroxide mixture (HPM) and the like, as well as alkaline cleaning chemical liquids such as an ammonia-hydrogen peroxide mixture (APM) and the like.

However, the conventional rinse treatment described above has problems or disadvantages. More particularly, it requires a large amount of pure water when the cleaning chemical liquid which is hard to dissolve in pure water is used. Another disadvantage is that an increase in diameter of the cleaned object causes an increase in the amount of cleaning chemical liquid introduced into the rinse bath while being carried on the cleaned object, leading to a tendency to require a larger amount of pure water. Further, it fails to permit the cleaning chemical liquid to be fully removed by only pure water.

### SUMMARY OF THE INVENTION

The present invention has been made in view of the foregoing disadvantages of the prior art.

Accordingly, it is an object of the present invention to provide a method for rinsing a cleaned object which is capable of substantially reducing the amount of pure water used for rinsing.

It is another object of the present invention to provide a method for rinsing a cleaned object which is capable of permitting a cleaning chemical liquid adhered to the cleaned object to be substantially fully removed therefrom.

In accordance with one aspect of the present invention, a method for rinsing a cleaned object which has been cleaned with a cleaning chemical liquid having acidity or alkalinity is provided. The method includes the steps of: immersing the object in a rinse bath filled therein with pure water; continuously feeding pure water to the rinse bath so as to rinse off the cleaning chemical liquid from a surface of the object; and adding a neutralizing chemical liquid which has alkalinity or acidity opposite to that of the cleaning chemical liquid to the pure water in the rinse bath.

In a preferred embodiment of the present invention, the pure water in the rinse bath is permitted to overflow the rinse bath so that a salt produced by neutralization of the cleaning chemical liquid adhered to the object by the neutralizing chemical liquid is outwardly discharged from the rinse bath together with the pure water overflowing the rinse bath.

In a preferred embodiment of the present invention, the neutralizing chemical liquid is emitted together with pure water toward the object in the rinse bath.

In a preferred embodiment of the present invention, the neutralizing chemical liquid is added to the rinse bath after a predetermined period of time from the start of feeding of the pure water to the rinse bath has lapsed.

In a preferred embodiment of the present invention, the neutralizing chemical liquid is added to the rinse bath concurrently with the start of feeding of the pure water to the rinse bath.

In a preferred embodiment of the present invention, the cleaning chemical liquid is one of a sulfuric acid-hydrogen peroxide mixture and a hydrochloric acid-hydrogen peroxide mixture. The neutralizing chemical liquid is an aqueous ammonia solution.

In a preferred embodiment of the present invention, the cleaning chemical liquid is an ammonia-hydrogen peroxide mixture. The neutralizing chemical liquid is sulfuric acid.

In accordance with another aspect of the present invention, an apparatus for rinsing a cleaned object which has been cleaned with a cleaning chemical liquid having acidity or alkalinity is provided. The apparatus includes a rinse bath of the continuous water feed type which is filled therein with pure water for rinsing, a neutralizing chemical liquid tank in which a neutralizing chemical liquid having alkalinity or acidity opposite to that of the cleaning chemical liquid is stored, a neutralizing chemical liquid feed means for feeding the neutralizing chemical liquid stored in the neutralizing chemical liquid tank to the pure water in the rinse bath, and a control means for controlling operation of the neutralizing chemical liquid feed means to control the amount of the neutralizing chemical liquid fed to the pure water and the timing of feeding the neutralizing chemical liquid to the pure water.

In a preferred embodiment of the present invention, the rinse bath is provided with a pure water recovery tank so that a salt produced by neutralization of the cleaning chemical liquid adhered to the object by the neutralizing chemical liquid may be discharged to the pure water recovery tank while the pure water is overflowing the rinse bath.

In a preferred embodiment of the present invention, the apparatus further includes a pure water feed passage connected to the rinse bath. The neutralizing chemical liquid feed means includes a neutralizing chemical liquid feed pump connected to the neutralizing chemical liquid tank and the pure water feed passage. The control means includes a pump controller for controlling a feed rate of the neutralizing chemical liquid by the pump.

In a preferred embodiment of the present invention, the pump controller controls the pump so as to permit the neutralizing chemical liquid to be fed after a predetermined period of time from the start of feeding of the pure water to the rinse bath has lapsed.

In a preferred embodiment of the present invention, the pump controller controls the pump so as to permit the neutralizing chemical liquid to be fed concurrently with the start of feeding of the pure water to the rinse bath.

Thus, in the present invention, the neutralizing chemical liquid stored in the neutralizing chemical liquid tank is added to the pure water in the rinse bath by means of the neutralizing chemical liquid feed means and control means. This permits the cleaning chemical liquid introduced into the rinse bath while being carried on the object to be neutralized, resulting in a salt being produced, which salt is then outwardly discharged together with the pure water overflowing the rinse bath.

### BRIEF DESCRIPTION OF THE DRAWINGS

These and other objects and many of the attendant advantages of the present invention will be readily appreciated as the same becomes better understood by reference to the following detailed description when considered in connection with the accompanying drawings in which like reference numerals designate like or corresponding parts throughout; wherein:

FIG. 1 is a diagrammatic view schematically showing an embodiment of the present invention;

FIG. 2 is a graphical representation showing results of measurement of a variation in resistivity of pure water occurring when a cleaned silicon wafer is rinsed according to the present invention;

FIG. 3 is a graphical representation showing results of measurement of the amount of sulfate ions remaining on a surface of a cleaned silicon wafer when the silicon wafer is rinsed according to the present invention; and

FIG. 4 is a diagrammatic view schematically showing conventional cleaning and rinsing units.

### DETAILED DESCRIPTION OF THE PREFERRED EMBODIMENT

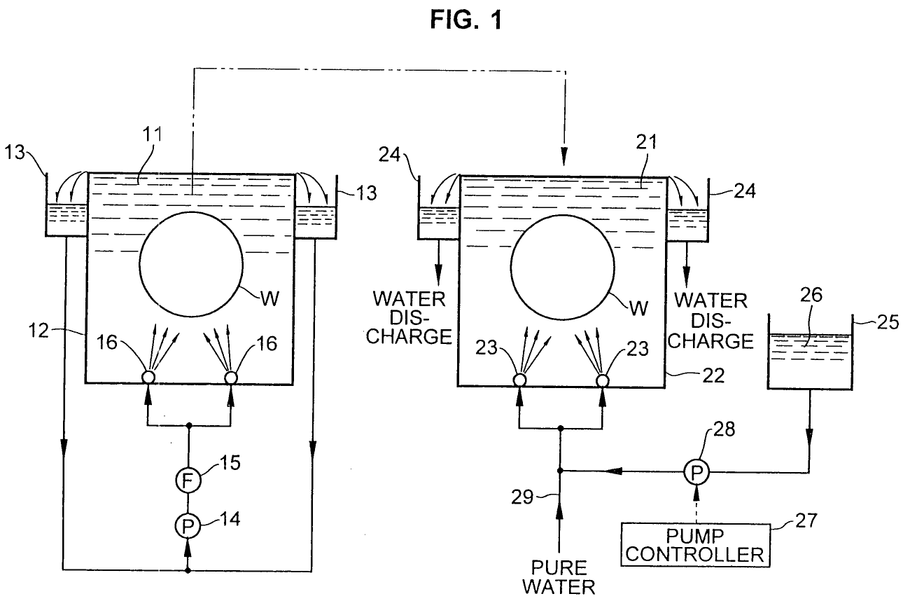

Now, the present invention will be described hereinafter with reference to FIGS. 1 to 3.

Referring first to FIG. 1, an embodiment of an apparatus for rinsing a cleaned object according to the present invention is illustrated. An apparatus of the illustrated embodiment includes a rinse bath 22, which is equipped with a neutralizing chemical liquid tank 25 in which a neutralizing chemical liquid 26 for neutralizing a cleaning chemical liquid 11 is stored. The neutralizing chemical liquid 26 is fed to a pure water feed passage 29 by means of a neutralizing chemical liquid feed pump 28 while being controlled by a pump controller 27, to thereby be added to pure water 21 stored in the rinse bath 22. Such addition of the neutralizing chemical liquid 26 having alkalinity or acidity opposite to acidity or alkalinity of the cleaning chemical liquid 11 permits the cleaning chemical liquid introduced into the rinse bath 22 while being carried on a cleaned object W to be neutralized by the neutralizing chemical liquid 26, to thereby be converted into a salt which is readily soluble in the pure water 21. The thus produced salt is then outwardly discharged together with the pure water 21 overflowing the rinse bath 22.

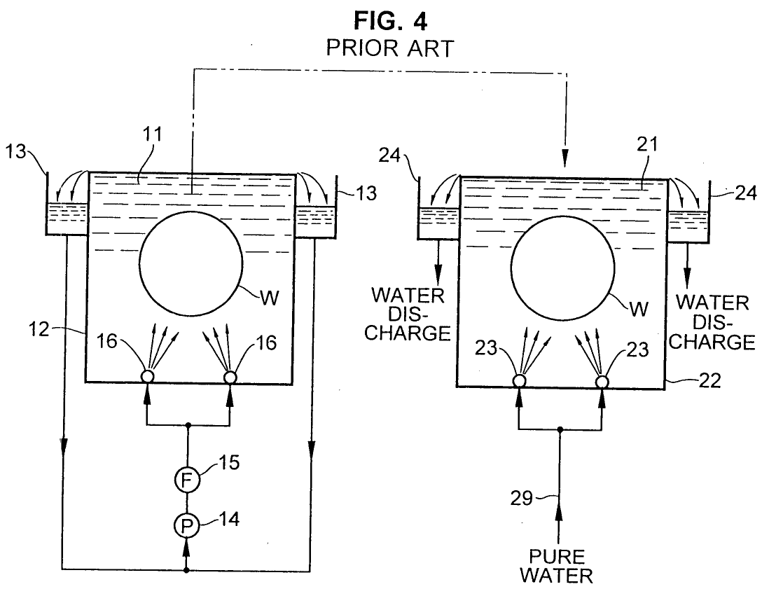

The remaining part of the illustrated embodiment may be constructed in substantially the same manner as the prior art described above with reference to FIG. 4.

For example, supposing that an acidic SPM liquid mainly comprised of sulfuric acid (H₂SO₄) is used as the cleaning chemical liquid 11, an aqueous ammonia solution (NH₄OH) which is alkaline may be used as the neutralizing chemical liquid 26. The aqueous ammonia solution is added in an appropriate amount to the pure water 21 in the rinse bath 22. This permits a neutralization reaction to take place in the rinse bath 22, as follows:

H₂SO₄+2NH₄OH—(NH₄)₂SO₄+2H₂O

Thus, the sulfuric acid is converted into ammonium sulfate ((NH₄)₂SO₄), which is then discharged to the pure water recovery tank 24 together with the pure water 21 overflowing the rinse bath 22.

When an alkaline APM liquid mainly comprised of an aqueous ammonia solution (NH₄OH) is used as the cleaning chemical liquid 11, sulfuric acid (H₂SO₄) which is acidic may be used as the neutralizing chemical liquid 26. The sulfuric acid is added in an appropriate amount to the pure water 21 in the rinse bath 22, so that a neutralization reaction takes place in the rinse bath 22, as follows:

2NH₄OH+H₂SO₄→(NH₄)₂SO₄+2H₂O

Thus, ammonia is converted into ammonium sulfate ((NH₄)₂SO₄), which is then discharged to the pure water recovery tank 24 together with the pure water 21 overflowing the rinse bath 22. Thus, addition of the neutralizing chemical liquid 26 exhibiting acidity or alkalinity opposite to alkalinity or acidity of the cleaning chemical liquid 11 to the pure water 21 in the rinse bath 22 permits the cleaning chemical liquid introduced into the rinse bath 22 while being carried on the cleaned object W to be reliably and readily removed from the cleaned object W. This permits the amount of pure water 21 used for rinsing to be substantially reduced and the cleaning chemical liquid 11 adhered to the cleaned object W to be fully removed from the object.

The amount of the neutralizing chemical liquid 26 which is added to the pure water 21 and the timing of addition of the neutralizing chemical liquid 26 are varied depending on a volume of each of a cleaning chemical liquid bath 12 and the rinse bath 22, a size of the cleaned object W and surface properties thereof, a type of the cleaning chemical liquid 11, a flow rate at which the pure water 21 is fed to the rinse bath 22, and the like. For example, the neutralizing chemical Liquid 26 may be added in a full amount at a time at the time when the rinse is begun, i.e., concurrently with the start of feeding of the pure water to the rinse bath. Alternatively, it may be added in several times with the lapse of time or continuously added according to a constant flow rate curve or a predetermined flow rate curve with the lapse of time. Most simply, the neutralizing chemical liquid feed pump 28 may be controlled by the pump controller 27 according to the amount of the neutralizing chemical liquid to be added and the timing of addition of the neutralizing chemical liquid which are optimum for the cleaning and rinsing units and which are previously determined by an experiment or the like.

As can be seen from the foregoing, in the method of the present invention, the neutralizing chemical liquid having alkalinity or acidity opposite to acidity or alkalinity of the cleaning chemical liquid is added to the pure water in the rinse bath. This permits the cleaning chemical liquid introduced into the rinse bath while being adhered to the cleaned object to be neutralized, to thereby be converted into a salt readily soluble in pure water. Then, the salt is outwardly discharged together with the pure water overflowing the rinse bath. Thus, the method of the present invention permits a substantial reduction in quantity of pure water required for rinsing. Also, the method of the present invention permits the cleaning chemical liquid adhered to the cleaned object to be substantially fully removed therefrom.

Further, the apparatus of the present invention includes the rinse bath of the continuous water feed type which is filled therein with pure water for rinsing, the neutralizing chemical liquid tank in which the neutralizing chemical liquid for neutralizing alkalinity or acidity of the cleaning chemical liquid is stored, the neutralizing chemical liquid feed means for feeding the neutralizing chemical liquid stored in the neutralizing chemical liquid tank to the pure water in the rinse bath, and the control means for controlling operation of the neutralizing chemical liquid feed means to control the amount of neutralizing chemical liquid fed to the pure water and the timing of feeding the neutralizing chemical liquid to the pure water. Such construction of the apparatus permits the amount of pure water used and a period of time required for rinsing to be substantially reduced as compared with the prior art.

The invention will be understood more readily with reference to the following example; however, the example is intended to illustrate the invention and is not to be construed to limit the scope of the invention.

### EXAMPLE

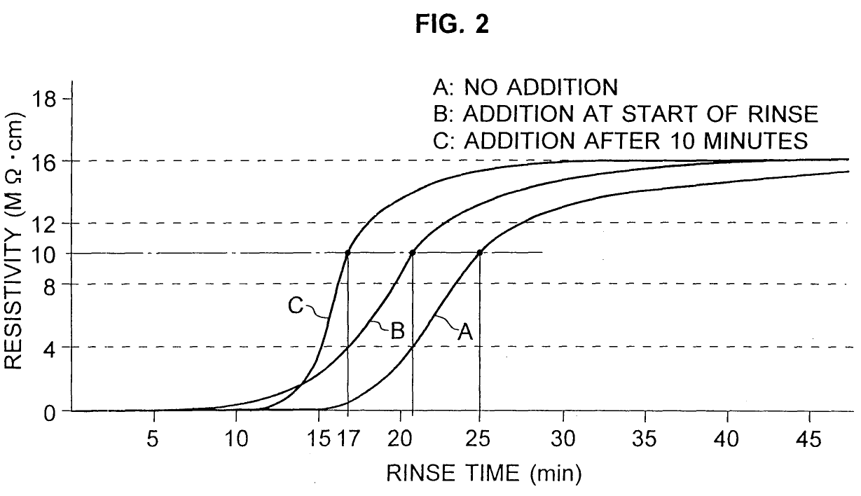

Silicon wafers each having a diameter of 12 inches (about 30 cm) were subjected to cleaning and rinsing by means of the cleaning and rinsing units shown in FIG. 1 and a variation in resistivity of the pure water 21 in the rinse bath 22 was measured. The results are shown in FIG. 2. An increase in resistivity indicates an increase in purity of the pure water 21. For reference, theoretical ultrapure water has a resistivity of about 18.25 MΩ·cm. In the example, an SPM liquid (a volumetric formulation ratio between sulfuric acid and hydrogen peroxide=1:5) was used as the cleaning chemical liquid 11 and an aqueous ammonia solution (NH₄OH) was used as the neutralizing chemical liquid 26. The neutralizing chemical liquid 26 was added in a full amount to the pure water at a time.

FIG. 2 clearly indicates that addition of the neutralizing chemical liquid (curves B and C) permitted the cleaning chemical liquid in the pure water to be particularly rapidly removed as compared with no addition of the neutralizing chemical liquid (curve A). In this instance, addition of the neutralizing chemical liquid in 10 minutes after the start of rinsing (curve C) permitted the cleaning chemical liquid to be satisfactorily removed as compared with addition of the neutralizing chemical agent at the time of the start of rinsing (curve B). This would be for the reason that addition of the neutralizing chemical liquid at the time of the start of rinsing causes the added neutralizing chemical liquid to flow out together with the pure water overflowing the rinse bath before the cleaning chemical liquid adhered to a surface of the cleaned object W is rinsed off from the object W by the pure water.

In general, completion of rinsing of a silicon wafer is judged by whether a resistivity of pure water in a rinse bath is restored to a level of about 10 MΩ·cm. In the example, as shown in FIG. 2, supposing that judgment of completion of rinsing is made at the time when the resistivity is restored to a level of 10 MΩ·cm, the rinsing was completed in about 25 minutes when the neutralizing chemical liquid was not added; whereas the rinsing was completed in about 21 minutes and about 17 minutes when the neutralizing chemical liquid was added at the time of the start of rinsing and was added in 10 minutes after the start of rinsing, respectively. Thus, addition of the neutralizing chemical liquid in 10 minutes after the start of rinsing (curve C) permitted time required for rinsing to be reduced by about 30% as compared with no addition of the neutralizing chemical liquid (curve A). This means that the amount of pure water used is reduced by about 30%.

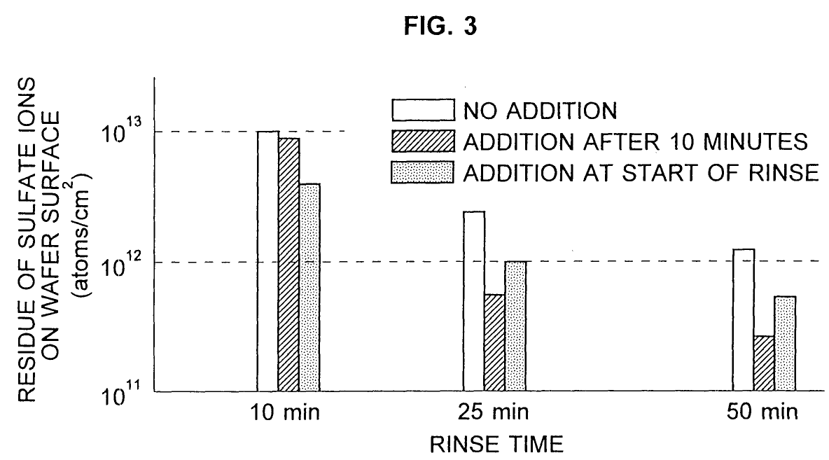

Also, the amount of the cleaning chemical liquid remained on the surface of the silicon wafer was measured. The measurement was carried out in connection with the number of sulfate ions (SO₄²⁻) remaining on the surface of the silicon wafer. The results are shown in FIG. 3. It will be noted from FIG. 3 that addition of the neutralizing chemical liquid permits the amount of cleaning chemical liquid remaining on the surface of the silicon wafer to be remarkably reduced.

While a preferred embodiment of the invention has been described with a certain degree of particularity with reference to the drawings, obvious modifications and variations are possible in light of the above teachings. It is therefore to be understood that within the scope of the appended claims, the invention may be practiced otherwise than as specifically described.

1. A continuous method for rinsing a cleaned object, which has been cleaned with a cleaning chemical liquid having acidity or alkalinity, comprising the steps of:
immersing the object in a rinse bath filled therein with pure water;
continuously feeding pure water to the rinse bath so as to rinse off the cleaning chemical liquid from a surface of the object;
adding a neutralizing chemical liquid, which has alkalinity or acidity opposite to that of the cleaning chemical liquid, to the pure water in the rinse bath during said continuous feeding of said pure water to said rinse bath thereby producing a salt by neutralizing said cleaning chemical liquid with said neutralizing chemical liquid; and
continuously overflowing said rinse bath thereby discharging the residual pure water and said salt from said rinse bath.

2. The method as defined in claim 1, wherein the neutralizing chemical liquid is emitted together with the pure water toward the cleaned object in the rinse bath.

3. The method as defined in claim 1, wherein the neutralizing chemical liquid is added to the rinse bath after a predetermined period of time from the start of feeding of the pure water to the rinse bath has lapsed.

4. The method as defined in claim 1, wherein the neutralizing chemical liquid is added to the rinse bath concurrently with the start of feeding of the pure water to the rinse bath.

5. The method as defined in claim 1, wherein the cleaning chemical liquid is one of a sulfuric acid-hydrogen peroxide mixture and a hydrochloric acid-hydrogen peroxide mixture and the neutralizing chemical liquid is an aqueous ammonia solution

6. The method as defined in claim 1, wherein the cleaning chemical liquid is an ammonia-hydrogen peroxide mixture and the neutralizing chemical liquid is sulfuric acid.

7. The method as defined in claim 1, wherein the cleaned object is selected from the group consisting of a semiconductor wafer, a silicon wafer and glass components for liquid crystal displays.

8. A continuous method for rinsing a cleaned object which has previously been cleaned with a cleaning chemical having acidity or alkalinity, comprising the steps of:
immersing said cleaned object in a rinse bath containing pure water;
continuously feeding pure water to said rinse bath so as to rinse off residual cleaning chemical from a surface of said cleaned object;
adding a neutralizing chemical which has alkalinity or acidity opposite to that of the cleaning chemical to said pure water in said rinse bath; reacting said neutralizing chemical and said residual cleaning chemical to form a salt; and removing said object from said rinse bath, said rinsing process being conducted using a single immersion step.

9. The method is defined in claim 8 wherein the said rinse bath is continuously overflowed thereby discharging residual pure water, neutralizing chemical and salt.

10. The method as defined in claim 9, wherein the said neutralizing chemical is added to said rinse bath after a predetermined period of time from the start of feeding of said pure water to said rinse bath as elapsed.

11. The method as defined in claim 9 wherein said neutralizing chemical is added to said rinse bath concurrently with the start of feeding of said pure water to said rinse bath.

12. The method as defined in claim 8 wherein the cleaning chemical is a sulfuric acid-hydrogen peroxide mixture or a hydrochloric acid-hydrogen peroxide mixture and wherein said neutralizing chemical is an aqueous ammonia solution.
